(19) United States
(12) Patent Application Publication
(10) Pub. No.: US 2012/0318968 A1
(43) Pub. Date: Dec. 20, 2012

(54) Sourceless Density Measurement Using Activation

(75) Inventor: Feyzi Inanc, Spring, TX (US)

(73) Assignee: Baker Hughes Incorporated, Houston, TX (US)

(21) Appl. No.: 13/495,226

(22) Filed: Jun. 13, 2012

Related U.S. Application Data
(60) Provisional application No. 61/498,392, filed on Jun. 17, 2011.

(51) Int. Cl. G01V 5/08; G01V 5/04

(52) U.S. Cl. 250/269.1; 250/256

(57) ABSTRACT

The present disclosure relates to borehole logging methods and apparatuses for estimating at least one parameter of interest of an earth formation using nuclear radiation, particularly by detecting interactions between the earth formation and an activated radiation source. The method may include using nuclear radiation information from at least one nuclear radiation sensor to estimate a parameter of interest. The method may include separating a gross nuclear radiation count into separate nuclear radiation components. The method may also include activating a part of a downhole tool with neutron radiation. The apparatus may include at least one nuclear radiation sensor. The apparatuses may include an information processing device to perform the methods.

### CROSS-REFERENCE TO RELATED APPLICATION

This application claims priority from U.S. Provisional Patent Application Ser. No. 61/498,392, filed on 17 Jun. 2011, incorporated herein by reference in its entirety.

### FIELD OF THE DISCLOSURE

This disclosure generally relates to borehole logging methods and apparatuses for estimating formation properties using nuclear radiation based measurements.

### BACKGROUND OF THE DISCLOSURE

Oil well logging has been known for many years and provides an oil and gas well driller with information about the particular earth formation being drilled. In conventional oil well logging, during well drilling and/or after a well has been drilled, a nuclear radiation source and associated nuclear radiation sensors may be conveyed into the borehole and used to determine one or more parameters of interest of the formation. A rigid or non-rigid carrier is often used to convey the nuclear radiation source, often as part of a tool or a set of tools, and the carrier may also provide communication channels for sending information up to the surface.

### SUMMARY OF THE DISCLOSURE

In aspects, the present disclosure is related to methods and apparatuses for estimating at least one parameter of interest of a volume of interest of an earth formation using nuclear radiation based measurements.

One embodiment according to the present disclosure may include a method of estimating at least one parameter of interest of a volume of interest of an earth formation, comprising: estimating the at least one parameter of interest using a response from the volume of interest to radiation from at least one radionuclide on a carrier in a borehole in the earth formation, the at least one radionuclide being generated by neutron irradiation.

Another embodiment according to the present disclosure may include an apparatus for estimating at least one parameter of interest of a volume of interest of an earth formation comprising: a carrier configured to be conveyed in a borehole in the earth formation; at least one radionuclide disposed on the carrier; and a sensor configured to produce a signal indicative of a response of the volume of interest to the at least one radionuclide.

Another embodiment according to the present disclosure may include a non-transitory computer-readable medium product having instructions thereon that, when executed, cause at least one processor to perform a method, the method comprising: estimating the at least one parameter of interest using a response from the volume of interest to radiation from at least one radionuclide on a carrier in a borehole in the earth formation, the at least one radionuclide being generated by neutron irradiation.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a downhole tool deployed in a borehole along a drill string according to one embodiment of the present disclosure;

FIG. 2 shows a schematic of a nuclear sensor module for one embodiment according to the present disclosure;

FIG. 3 shows a flow chart for a method for one embodiment according to the present disclosure;

FIG. 4 shows a graph of variation of nuclear densities with time under constant neutron radiation for one embodiment according to the present disclosure;

FIG. 5 shows a graph of nuclear radiation counts for sensors in different positions for one embodiment according to the present disclosure;

FIG. 6 shows a graph of nuclear radiation information before and after separation into radiation components for one embodiment according to the present disclosure; and

FIG. 7 shows a schematic of an apparatus for implementing one embodiment of the method according to the present disclosure.

### DETAILED DESCRIPTION

In aspects, this disclosure relates to estimating at least one parameter of interest of a volume of interest of an earth formation using a radionuclide generated by neutron irradiation.

The application of neutrons may cause “activation” of specific nuclides (iron, silicon, and oxygen) that may be found in a downhole environment. The neutrons may cause some nuclides to be converted into radionuclides that are not stable. Radionuclides generally give off ionizing radiation, such as gamma rays, during their delayed decay. The term “activation” relates to the conversion of a normally stable nuclide into a radionuclide through a nuclear process, such as, but not limited to, neutron-proton (n,p) reactions and radiative capture (n,γ). Depending on the radionuclide, the delayed decay spectrum may have characteristics that allow the radionuclide to be used as a nuclear radiation source. Herein, the term “nuclear radiation” includes particle and non-particle radiation emitted by atomic nuclei during nuclear processes (such as radioactive decay and/or nuclear bombardment), which may include, but are not limited to, photons from neutron inelastic scattering and from neutron thermal capture reactions, neutrons, electrons, alpha particles, beta particles, and pair production photons.

For example, in typical Logging-While-Drilling (LWD) tools, there may be a significant amount of iron in the tool structure. The significant portion of the iron, about 92%, may be iron-56. When iron-56 is irradiated by neutrons, the interaction of the neutrons with some iron-56 nuclides may be result in manganese-56 radionuclides. Manganese-56 may later decay and emit certain gamma rays. The buildup of gamma emitting radionuclides in the downhole tool due to activation may reach asymptotic values, thus providing a constant gamma source.

In a typical logging environment, LWD tools stay in the borehole for extended time periods while exposed to a neutron source. The neutron source may include, but is not limited to, one or more of: a chemical neutron source and a pulsed neutron generator. Regular exposure to the neutron source may result in a stable radionuclide population in at least one part of a downhole tool that includes one or more radionuclides. The at least one part of the downhole tool may include a drill collar. The radionuclides in the at least one part of the downhole tool may emit nuclear radiation that may interact with the earth formation after the neutron source has been turned off. The interaction of the nuclear radiation from the radionuclides may result radiation emission from the earth formation.

In a non-limiting exemplary implementation, neutron logging may be performed using a three time bin configuration. During the first time bin, one or more nuclear radiation sensors may detect photons being emitted as a result of inelastic neutron scattering interactions, capture of thermal neutrons (neutrons that slowed down while the pulsed neutron generator is still on), and photons from radionuclides that go through delayed decay due to a volume of interest of an earth formation being exposed to neutron radiation. During the second time bin, the nuclear radiation sensor(s) may detect photons from neutron capture reactions and decay of radionuclides due to neutron activation. During the third time bin, the detector(s) may detect photons from the delayed decay of radionuclides produced through activation interactions. Activation interactions may generate radionuclides in the downhole tool and the earth formation. Since the logging tool is generally in motion, the buildup of radionuclides in the earth formation may be low relative to the buildup of radionuclides in the tool. The downhole tool may be exposed to neutrons for an extended period of time, since the neutron source may remain in close proximity to the tool during the logging operation.

Thus, after the neutron source is turned off and thermal neutrons disappeared due to capture and diffusion, one or more nuclear radiation sensors disposed on the downhole tool may detect radiation due to radionuclides in the tool and in the earth formation that have been activated by neutron irradiation. The radionuclides (and their corresponding nuclides) may be described as nuclide-radionuclide pairs formed by nuclear interactions, such that a radionuclide may be formed from a nuclide that has been exposed to neutron radiation. The nuclear interactions may include, but are not limited to, neutron-proton reactions (n,p) and thermal neutron capture (n,γ). The nuclide-radionuclide pairs may include, but are not limited to, one more of: (i) oxygen-16→nitrogen-16 (n,p), (ii) sodium-23→neon-23 (n,p), (iii) sodium-23→sodium-24 (n,γ), (iv) magnesium-24→sodium-24 (n,p), (v) aluminum-27 →aluminum-28 (n,γ), (vi) aluminum-27→magnesium-27 (n,p), (vii) silicon-28→aluminum-28 (n,p), (viii) iron-56→manganese-56 (n,p), and (ix) iodine-127→iodine-128 (n,γ).

The one or more nuclear radiation sensors disposed along the downhole tool may be configured to generate a signal indicative of the nuclear radiation detected. The detected nuclear radiation may include gamma rays. Since a gamma ray count may include gamma rays from radionuclides of multiple elements, the gamma ray count information may be separated using a model into gamma ray components associated with each element. Herein, “information” may include raw data, processed data, analog signals, and digital signals. In some embodiments, the model may include, but is not limited to, one or more of: (i) a mathematical equation, (ii) an algorithm, (iii) an energy spectrum deconvolution technique, (iv) a stripping technique, (v) an energy spectrum window technique, (vi) a time spectrum deconvolution technique, and (vii) a time spectrum window technique. The gamma ray component for at least one radionuclide may be used to estimate at least one parameter of interest of the earth formation. The at least one parameter of interest may include, but is not limited to, one or more of: (i) density, (ii) porosity, and (iii) fluid saturation. A description for some embodiments estimating the at least one parameter of interest follows below.

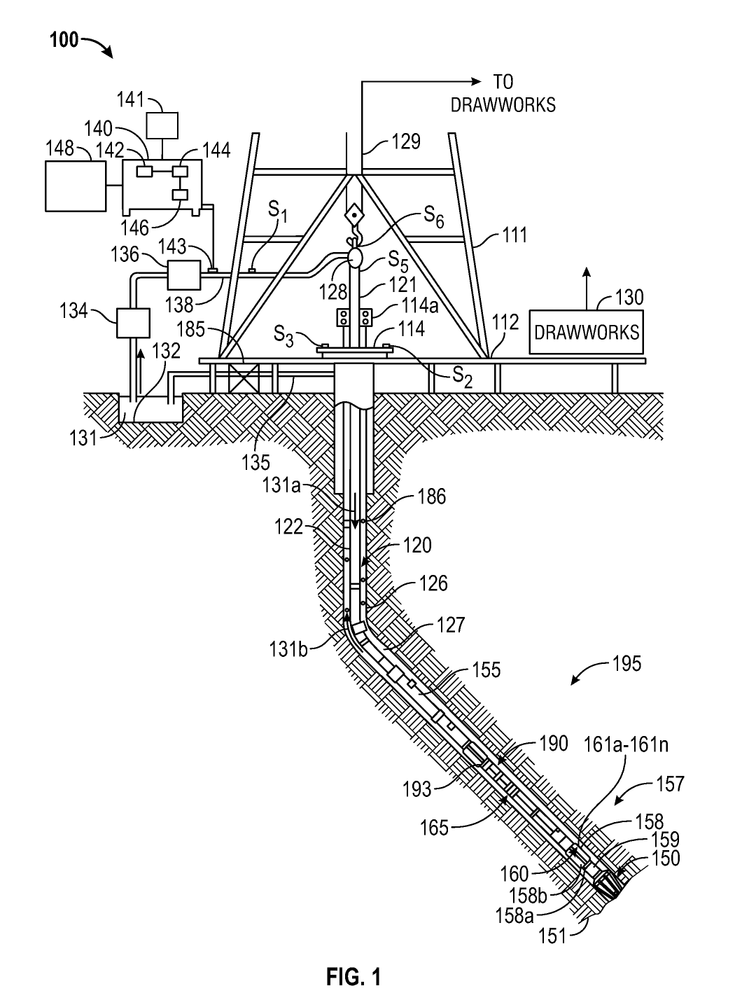

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe 122), having the drilling assembly 190, attached at its bottom end extends from the surface to the bottom 151 of the borehole 126. A drill bit 150, attached to drilling assembly 190, disintegrates the geological formations when it is rotated to drill the borehole 126. The drill string 120 is coupled to a drawworks 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration (ROP) for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 141 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA 190 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 195 surrounding the BHA 190. Such sensors are generally known in the art and for convenience are generally denoted herein by numeral 165. The BHA 190 may further include a variety of other sensors and devices 159 for determining one or more properties of the BHA 190 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The BHA 190 may include a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The drilling system 100 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling, and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The drilling system 100 can include one or more downhole processors at a suitable location such as 193 on the BHA 190. The processor(s) can be a microprocessor that uses a computer program implemented on a suitable non-transitory computer-readable medium that enables the processor to perform the control and processing. The non-transitory computer-readable medium may include one or more ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. While a drill string 120 is shown as a conveyance system for sensors 165, it should be understood that embodiments of the present disclosure may be used in connection with tools conveyed via rigid (e.g. jointed tubular or coiled tubing) as well as non-rigid (e. g. wireline, slickline, e-line, etc.) conveyance systems. The drilling system 100 may include a bottomhole assembly and/or sensors and equipment for implementation of embodiments of the present disclosure on either a drill string or a wireline. A point of novelty of the system illustrated in FIG. 1 is that the surface processor 142 and/or the downhole processor 193 are configured to perform certain methods (discussed below) that are not in prior art.

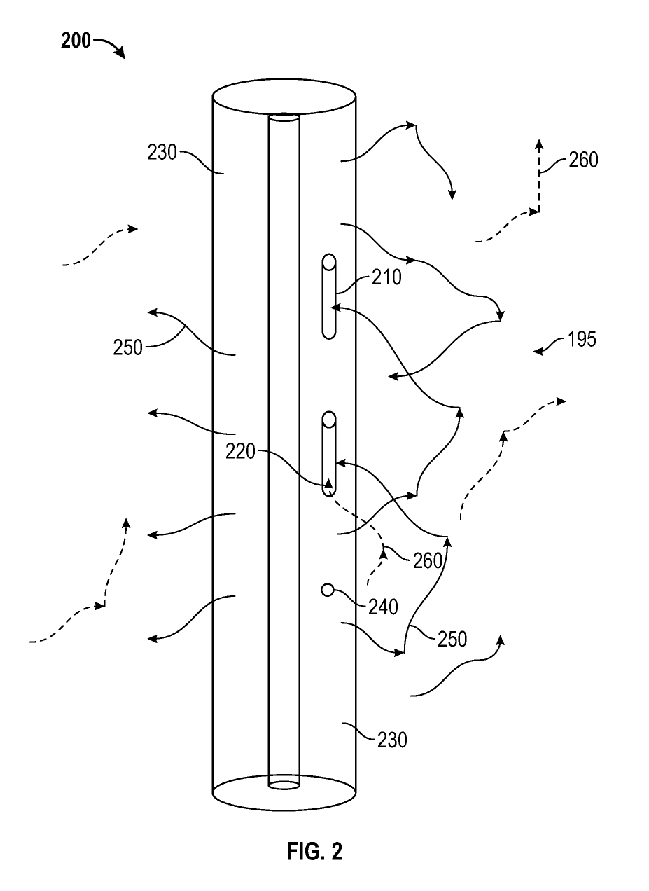

FIG. 2 shows a nuclear detection module 200 that may be incorporated in BHA 190, such as along with evaluation sensors 165 according to one embodiment of the present disclosure. The nuclear detection module 200 may include one or more sensors 210, 220 configured to detect nuclear radiation disposed along a drill collar 230. The one or more nuclear radiation sensors 210, 220 may be spaced at different distances along the drill collar 230 apart from a neutron source 240. When neutron source 240 is turned on, emitted neutrons may generate radionuclides in the drill collar 230. The drill collar 230 may then serve as a gamma radiation source. When the neutron source 240 is turned off and after delayed neutron emissions have stopped, the drill collar 230 may still be emitting nuclear radiation 250 into the earth formation 195. The interaction with the nuclear radiation 250 and the earth formation 195 may result in a nuclear radiation response 260 from the formation. Nuclear radiation 260 may be the result of gamma ray scattering by the earth formation 195. Detectors 210, 220 may receive a nuclear radiation response 250 from the drill collar 230 and nuclear radiation 260 from the earth formation 195. The accumulation of radionuclides in drill collar 230 is exemplary and illustrative only, as other components of the BHA 190 may accumulate radionuclides, including components that do not contain iron-56. In some embodiments, the nuclear detection module 200 may not include a neutron source 240, and the radionuclides in the drill collar 230 may be generated by neutron irradiation by another neutron source located in the borehole 126 or at the surface.

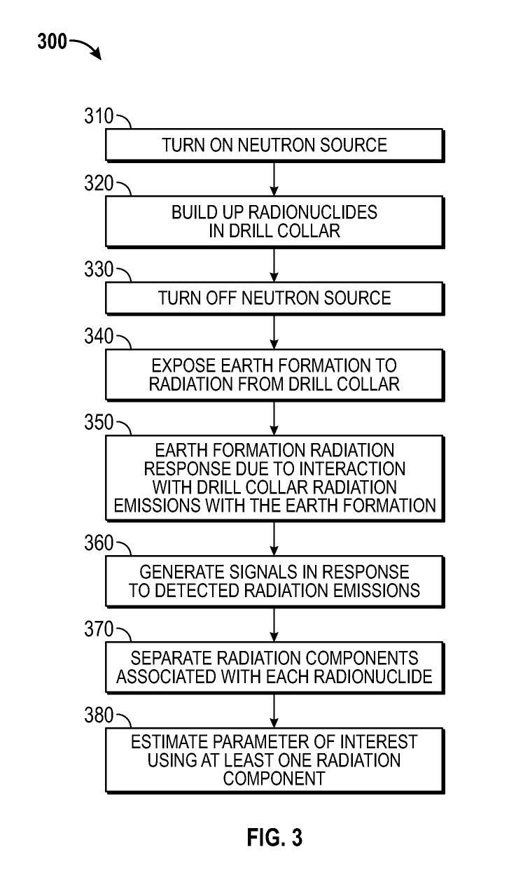

FIG. 3 shows a flow chart 300 for estimating at least one parameter of interest of the earth formation according to one embodiment of the present disclosure. In step 310, neutron source 240 may be turned on to expose at least part of the drill collar 230 to neutron radiation. In step 320, radionuclides build up in the drill collar 230 during neutron irradiation. The build-up of radionuclides may take place over one or more neutron irradiation cycles. In step 330, the neutron source may be turned off. In step 340, the drill collar 230 may expose the earth formation 195 to nuclear radiation emissions 250 due to the radionuclides. In step 350, interaction with the nuclear radiation emissions 250 and the earth formation 195 may result in nuclear radiation response 260 from earth formation 195. In step 360, one or more nuclear radiation sensors 210, 220 may generate signals in response to detected nuclear radiation emissions 250 and scattered nuclear radiation 260. In step 370, the signals representing nuclear radiation 250, 260 may be separated into nuclear radiation components associated with each of the radionuclides. In step 380, a parameter of interest of the formation may be estimated using at information about at least one nuclear radiation component of the earth formation 195. In some embodiments, steps 310-330 may be performed at the surface prior to the nuclear detection module 200 being conveyed into the borehole 26, and the irradiation of drill collar 230 may be performed using another neutron source.

Neutron source 240 may be any neutron generator, including, but not limited to, a pulsed neutron generator and a chemical neutron source. The nuclear radiation sensors 210, 220 may include detectors configured to detect gamma rays. In some embodiments, the at least one parameter of interest may include density. In some embodiments, separation into nuclear radiation components may involve applying a model. The model may include, but is not limited to, (i) a mathematical equation, (ii) an algorithm, (iii) an energy spectrum deconvolution technique, (iv) an energy spectrum stripping technique, (v) an energy spectrum window technique, (vi) a time spectrum deconvolution technique, (vii) a time spectrum window technique, or a combination thereof.

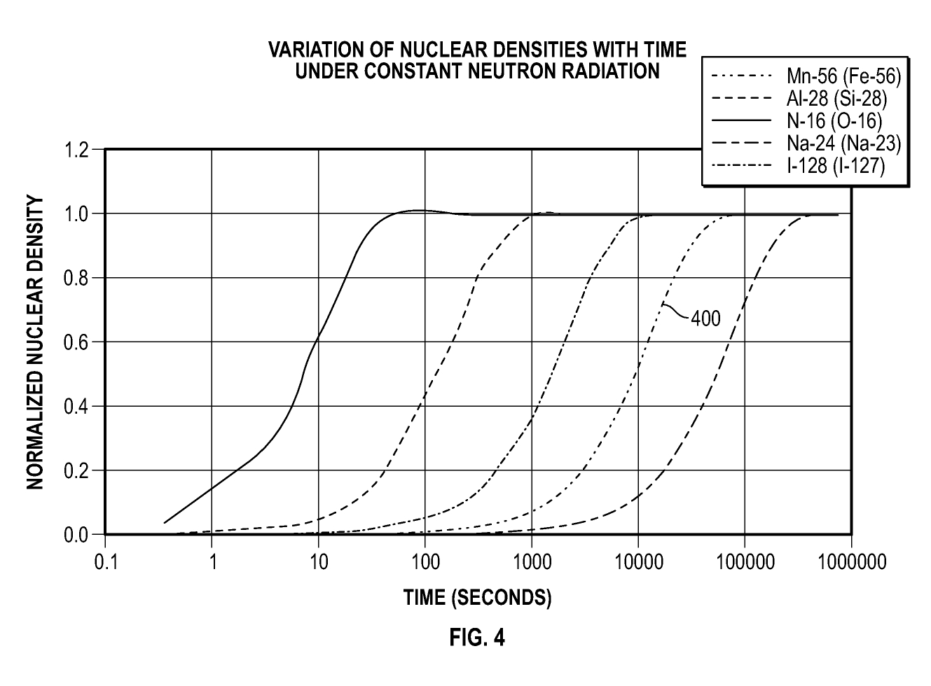

FIG. 4 shows a set of curves indicating a buildup of several radionuclides that may be encountered during nuclear logging. As shown, the curve 400 for manganese-56, which is a byproduct of iron-56 and neutron reactions, reaches an asymptotic value around 10 hrs. The radionuclides may form a gamma ray source. The gamma ray source may be used to estimating the density of the earth formation.

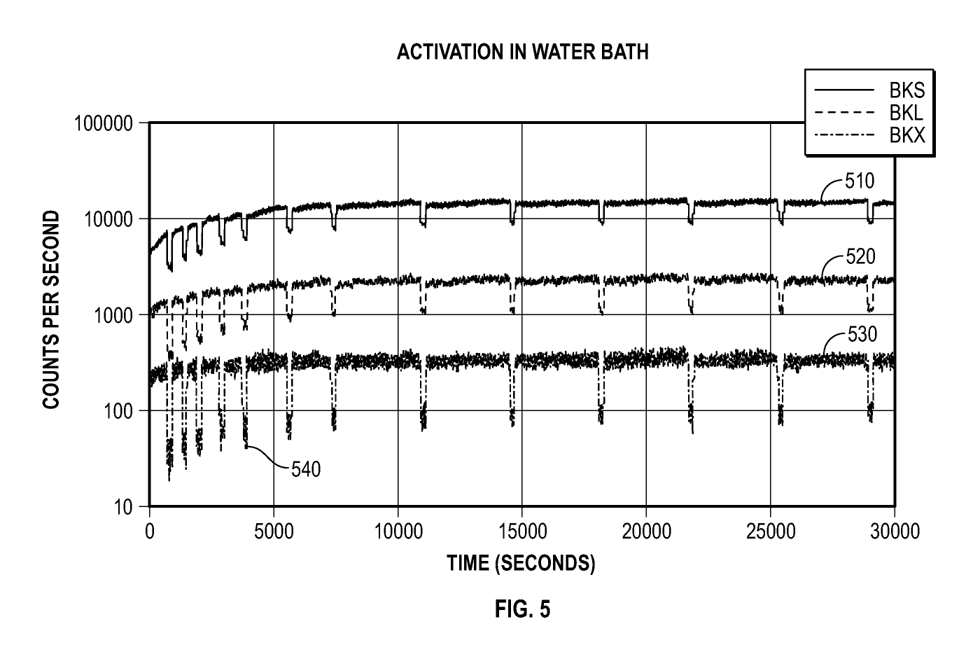

FIG. 5 shows a set of curves indicating the buildup of gamma ray counts detected, as three different detector distances from a neutron source, due to activation of nuclides over time. Curve 510 represents a gamma ray count from a detector closest to the neutron source. Curve 520 represents a gamma ray count from a middle detector. Curve 530 represents a gamma ray count from a detector furthest from the neutron source. In this example, background nuclear radiation may be observed from a tool where a pulsed neutron generator has operated for several hours. It may be observed that the gradual buildup of nuclear radiation counts may approach an asymptotic value around 10 hours. The dips 540 in the curves 510, 520, 530 may indicate the period where the neutron source may be turned off. Even when the pulsed neutron generator is off, there are photons being detected by the radiation sensors 210, 220. The detected photons may come from the tool and the components of the tool, such as a drill collar. When the tool has a large collar with high iron content, the neutron activation may cause a significant number of gamma photons to be emitted during the third time bin.

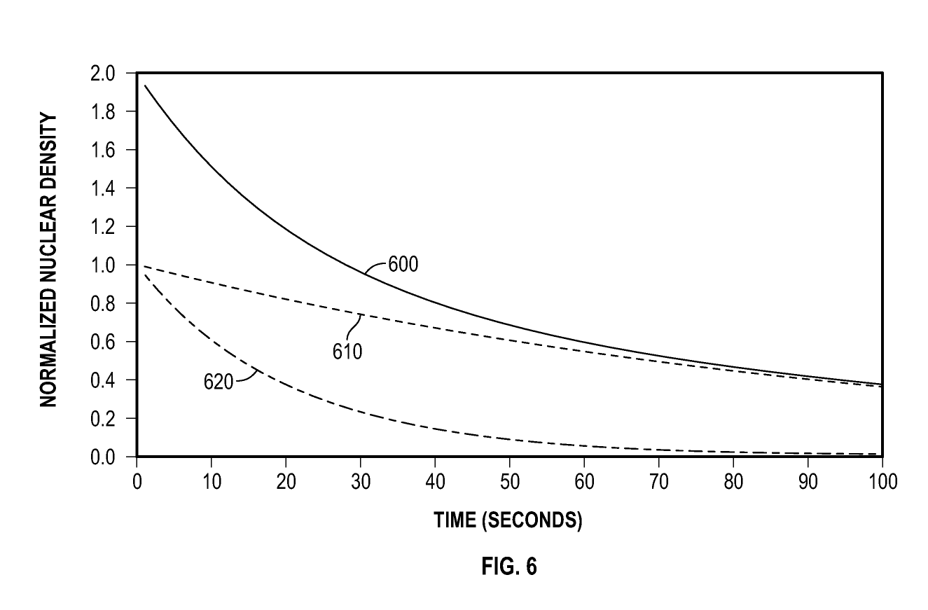

FIG. 6 shows a chart showing an example of radiation information before and after separation into a plurality of radiation components. Curve 600 may represent a signal generated from at least one radiation detector before separation. Curves 610, 620 may represent two radiation components, corresponding to two radionuclides (radionuclide A and radionuclide B), that may be realized by separation. In this example, the separation may be performed using time spectrum deconvolution, which is one non-limiting technique that may be used in a model for separating the radiation information into a plurality of radiation components. The curves 600, 610, 620 may be represented as:

N(t)=N_{A}e^{-λ}^{_{A}}^{t}+N_{B}e^{-λ}^{_{B}}^{t} (1)

where N(t) is the nuclear density value over time estimated by the at least one radiation detector and represented in curve 600, N_{A} is the nuclear density of radionuclide A at t=0, N_{B} is the nuclear density of radionuclide A at t=0, λ_{A} is the decay constant of radionuclide A, λ_{B} is the decay constant of radionuclide A, and t is time. Hence, N_{A}e^{-λ}^{_{A}}^{t} may mathematically express curve 610 and N_{B}e^{-λ}^{_{B}}^{t} may mathematically express curve 620.

The density change over time for radionuclides A and B may be written as:

$${N}_{B} = \frac{{N}_{2} - {N}_{1} {e}^{- {λ}_{A} ( {t}_{2} - {t}_{1} )}}{{e}^{- {λ}_{B} {t}_{2}} - {e}^{- ( {λ}_{B} - {λ}_{A} ) {t}_{1} - {λ}_{A} {t}_{2}}} ; \\ {N}_{A} = {N}_{1} {e}^{{λ}_{A} {t}_{1}} - {N}_{B} {e}^{- ( {λ}_{B} - {λ}_{A} ) {t}_{1}} \qquad ( 2 )$$

where N₁ and N₂ are the nuclear densities (on curve 600) at times t₁ and t₂ .

Using values for N₁, N₂, t₁, and t₂ from curve 600, radiation contributions for radionuclides A and B may be separated into curves 610, 620, which may be represented as N_{A}(t)=N_{A}e^{-λ}^{_{A}}^{t} and N_{B}(t)=N_{B}e^{-λ}^{_{B}}^{t}, respectively. While this example shows the separations of radiation information into two radiation components, this in no way limits the number of radiation components that may be separated out of the radiation information.

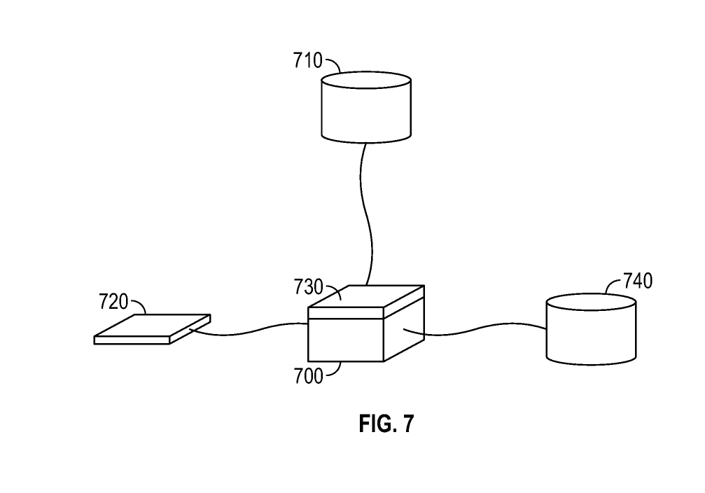

As shown in FIG. 7, certain embodiments of the present disclosure may be implemented with a hardware environment that includes an information processor 700, a information storage medium 710, an input device 720, processor memory 730, and may include peripheral information storage medium 740. The hardware environment may be in the well, at the rig, or at a remote location. Moreover, the several components of the hardware environment may be distributed among those locations. The input device 720 may be any information reader or user input device, such as data card reader, keyboard, USB port, etc. The information storage medium 710 stores information provided by the detectors. Information storage medium 710 may be any standard computer information storage device, such as a ROM, USB drive, memory stick, hard disk, removable RAM, EPROMs, EAROMs, EEPROM, flash memories, and optical disks or other commonly used memory storage system known to one of ordinary skill in the art including Internet based storage. Information storage medium 710 stores a program that when executed causes information processor 700 to execute the disclosed method. Information storage medium 710 may also store the formation information provided by the user, or the formation information may be stored in a peripheral information storage medium 740, which may be any standard computer information storage device, such as a USB drive, memory stick, hard disk, removable RAM, or other commonly used memory storage system known to one of ordinary skill in the art including Internet based storage. Information processor 700 may be any form of computer or mathematical processing hardware, including Internet based hardware. When the program is loaded from information storage medium 710 into processor memory 730 (e.g. computer RAM), the program, when executed, causes information processor 700 to retrieve detector information from either information storage medium 710 or peripheral information storage medium 740 and process the information to estimate a parameter of interest. Information processor 700 may be located on the surface or downhole.

While the foregoing disclosure is directed to the one mode embodiments of the disclosure, various modifications will be apparent to those skilled in the art. It is intended that all variations be embraced by the foregoing disclosure.

What is claimed is:

1. A method of estimating at least one parameter of interest of a volume of interest of an earth formation, comprising:
estimating the at least one parameter of interest using a response from the volume of interest to radiation from at least one radionuclide on a carrier in a borehole in the earth formation, the at least one radionuclide being generated by neutron irradiation.

2. The method of claim 1, wherein the activated radiation source is at least part of a housing of a downhole tool.

3. The method of claim 1, wherein the at least one parameter of interest includes at least one of:
(i) density, (ii) porosity, and (iii) fluid saturation of the volume of interest.

4. The method of claim 1, wherein the response includes gamma rays.

5. The method of claim 1, wherein the at least one radionuclide includes manganese-56.

6. The method of claim 1, further comprising:
generating the at least one radionuclide using a neutron source.

7. The method of claim 6, wherein the neutron source includes a pulsed neutron generator.

8. The method of claim 1, wherein the response is estimated when a neutron flux in the volume of interest is substantially zero.

9. The method of claim 1, further comprising:
generating information related to the response using a sensor in a borehole in the earth formation.

10. The method of claim 9, further comprising:
separating the information into a plurality of radiation components using a model.

11. The method of claim 10, wherein at least one of the plurality of radiation components includes a time decay.

12. The method of claim 10, wherein the model includes at least one of: (i) a mathematical equation, (ii) an algorithm, (iii) an energy spectrum deconvolution technique, (iv) a stripping technique, (v) an energy spectrum window technique, (vi) a time spectrum deconvolution technique, and (vii) a time spectrum window technique.

13. The method of claim 1, wherein estimating the at least one parameter of interest includes a time decay measurement technique.

14. The method of claim 1, further comprising:
conveying the at least one radionuclide into the borehole.

15. An apparatus for estimating at least one parameter of interest of a volume of interest of an earth formation comprising:
a carrier configured to be conveyed in a borehole in the earth formation;
at least one radionuclide disposed on the carrier; and
a sensor configured to produce a signal indicative of a response of the volume of interest to the at least one radionuclide.

16. The apparatus of claim 15, wherein the at least one radionuclide is at least part of a housing of a downhole tool.

17. The apparatus of claim 15, wherein the response includes gamma rays.

18. The apparatus of claim 15, wherein the at least one radionuclide includes manganese-56.

19. The apparatus of claim 15, further comprising:
a neutron source configured to generate the at least one radionuclide.

20. The apparatus of claim 19, wherein the neutron source includes a pulsed neutron generator.

21. The apparatus of claim 19, wherein the response is estimated when a neutron flux in the volume of interest is substantially zero.

22. The apparatus of claim 15, further comprising:
a processor configured to estimate the at least one parameter of interest using the signal.

23. The apparatus of claim 22, wherein the at least one parameter of interest is density of the volume of interest.

24. A non-transitory computer-readable medium product having instructions thereon that, when executed, cause at least one processor to perform a method, the method comprising:
estimating the at least one parameter of interest using a response from the volume of interest to radiation from at least one radionuclide on a carrier in a borehole in the earth formation, the at least one radionuclide being generated by neutron irradiation.

25. The non-transitory computer-readable medium product of claim 24 further comprising at least one of: (i) a ROM, (ii) an EPROM, (iii) an EEPROM, (iv) a flash memory, and (v) an optical disk.
